(19) United States
(12) Patent Application Publication
(10) Pub. No.: US 2007/0195167 A1
(43) Pub. Date: Aug. 23, 2007

(54) Image distribution system, image distribution server and image distribution method

(75) Inventor: Eiji Ishiyama, Saitama-ken (JP)

Correspondence Address: TAIYO CORPORATION, 401 HOLLAND LANE, #407, ALEXANDRIA, VA, 22314, US

(73) Assignee: FUJIFILM CORPORATION

(21) Appl. No.: 11/703,640

(22) Filed: Feb. 8, 2007

(30) Foreign Application Priority Data
Feb. 20, 2006 (JP) 2006042365

(51) Int. Cl. H04N 5/225

(52) U.S. Cl. 348/207.1

(57) ABSTRACT

An image distribution system includes an image storage device and an image distribution server. The image storage device includes a storage section which memorizes image data, and the image storage device switches into a mass storage mode when a switching signal is inputted. The image distribution server outputs the switching signal to the image storage device when there is a request from an external section, acquires the image data from the storage section of the image storage device which has switched to the mass storage mode, and distributes the acquired image data in response to a request from an image display browser.

### CROSS-REFERENCE TO RELATED APPLICATION

This application claims priority under 35 USC 119 from Japanese Patent Application No. 2006-42365, the disclosure of which is incorporated by reference herein.

### BACKGROUND OF THE INVENTION

1. Field of the Invention

The present invention relates to an image distribution system, an image distribution server and an image distribution method.

2. Description of the Related Art

Image data is accumulated in a device which captures and records images, such as a digital camera. In recent years, for easy viewing of images of such image data from a personal computer (PC) or the like, many systems employing Web servers and browsers have been proposed.

For example, systems have been proposed (see, for example, Japanese Patent Application Laid-open (JP-A) Nos. 2000-350145, 2003-141028, 2000-287110 and 2000-357169) which connect a server with a camera, acquire image files from the camera to which the server is connected, perform preparatory preparation for browser display (for example, creating an index.html file, creating thumbnail images and so forth), and then exhibit the image files using Web server functions. Thus, a user can view images from a PC or the like with an ordinary browser.

In the publication of JP-A No. 2003-141028, if there is image data in a special format which is not compatible with an ordinary browser, there is a function for converting the image data to a common format. In the publication of JP-A No. 2000-287110, server functions are incorporated in a digital camera. In the publication of JP-A No. 2000-357169, a Web server is a structure which goes as far as preparatory preparation for browser display, but server functions are treated as separate.

Anyway, the technologies described in these patent documents place emphasis on the aspect of exhibiting image data acquired from a camera using Web server functions, and do not give significant consideration to the aspect of how image data is acquired from the camera. For example, in the technology described in JP-A No. 2000-350145, a memory card is taken out from the camera and inserted into a Web server device to acquire the image data. Therefore, convenience for users is poor. In JP-A No. 2003-141028, only a digital camera being provided with an output terminal for output, by wire or by wireless, of electronic files constituted of captured electronic photographic information is described. In JP-A No. 2000-357169, it is only described that a PC launches an image view creation program for collecting image data from an electronic camera and that transfer processing of the image data is commenced. Neither JP-A No. 2003-141028 nor JP-A No. 2000-357169 discloses anything concrete at all about what kind of implementation is required. Further, in JP-A No. 2000-287110, because server functions are installed in the digital camera itself, unnecessary functions are being provided to those users who do not use the server functions.

Accordingly, a technology has been proposed (see, for example, JP-A No. 2002-094925) in which a camera controls a server and implements transfers of image data to the server under the guidance of the camera. A technology has also been proposed (see, for example, JP-A No. 2003-503932) in which a camera is directly connected to a PC that a user is operating, without a server therebetween, to serve as a directly connected high-capacity storage device, and images in the camera can be viewed in a browser at the PC.

However, with the technology described in JP-A No. 2002-094925, there are problems in that it becomes necessary to install special functions for data transfer and server control in the camera, and manufacturing costs of the camera rise.

Further, when a camera and a PC are connected using a cable as with the technology described in JP-A No. 2003-503932, it is only possible to connect one PC to the camera at one time. Therefore, it is not possible for a number of people to view the images. It is possible to connect a plurality of PCs at the same time if a protocol for disc sharing, such as file sharing, an NFS (Network File System) or the like, is employed at the PCs. However, operations of such protocols for disc sharing are slow, which is a disadvantage.

Currently, technologies are widely employed which automatically transfer captured image data from cameras and/or remotely control cameras from external devices with technologies which utilize standards such as USB, IEEE1394 and the like. Transfer of data from cameras to servers is possible using such technologies. However, there is a problem in that these technologies are only installed in some high-level models of camera and cannot be utilized with many cameras.

### SUMMARY OF THE INVENTION

The present invention has been made in view of the above circumstances and provides an image distribution system, an image distribution server and an image distribution method.

According to an aspect of the invention, there is provided an image distribution system comprising: an image storage device including a storage section which stores image data, the image storage device switching to a mass storage mode when a switching signal is inputted; and an image distribution server which outputs the switching signal to the image storage device when there is a request from an external section, acquires the image data from the storage section of the image storage device which has switched to the mass storage mode, and distributes the acquired image data in response to a request from an image display browser.

### BRIEF DESCRIPTION OF THE DRAWINGS

A preferred embodiment of the present invention will be described in detail based on the following figures, wherein:

FIG. 1 is a structural diagram showing general details of overall structure of an image viewing system relating to a present embodiment.

FIG. 2 is a structural diagram showing structure of a control system of a digital camera.

FIG. 3 is a structural diagram showing structure of a control system of an image distribution server.

FIG. 4 is a flowchart showing a flow of operations of the present image viewing system.

FIG. 5 is a flowchart showing details of processing at the image distribution server in a step 108 of FIG. 4.

FIGS. 6A to 6C are views showing examples of image list Web pages, which are displayed in an image display browser of a client terminal.

FIGS. 7A and 7B are views showing examples of Web display data (HTML data).

FIG. 8 is a flowchart showing a flow of operations of the image distribution server at a time of start-up.

FIGS. 9A and 9B are display examples of an image viewing Web page.

FIG. 10 is a view showing a description example of a “transfer.cgi” script which is launched by the image distribution server, having received a request from the image display browser of the client terminal.

FIG. 11 is a flowchart showing a flow of processing of a “transfer_check_and_exec” function which is executed by the image distribution server.

### DETAILED DESCRIPTION OF THE INVENTION

Herebelow, an example of an embodiment of the present invention will be described in detail with reference to the drawings.

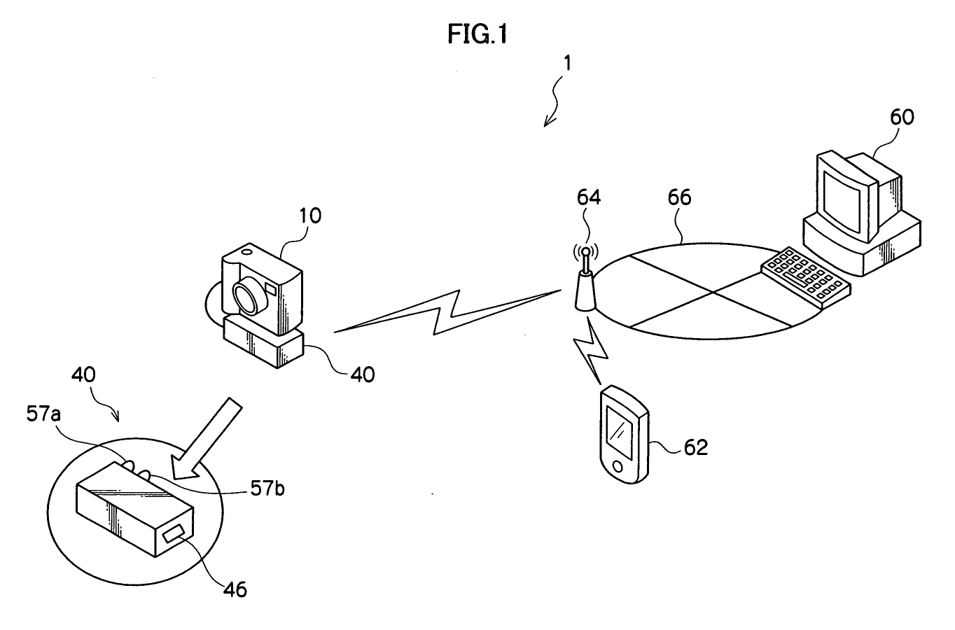

FIG. 1 is a structural view showing general details of overall structure of an image viewing system 1 relating to the present embodiment. This image viewing system 1 is structured with a digital camera 10, an image distribution server 40 which can be connected with the digital camera 10, a PC (personal computer) 60 and a PDA (a personal digital assistant, which is a portable information terminal) 62. The PC 60 and the PDA 62 serve as client terminals in which image display browsers are installed, which request distribution from the image distribution server 40 of image data of images captured by the digital camera 10, and display the images. Herein, this digital camera 10 is an example of an image storage device structuring an image distribution system of the present invention, and the image viewing system 1 is structured to include the image distribution system, which is structured to include the digital camera 10 and the image distribution server 40.

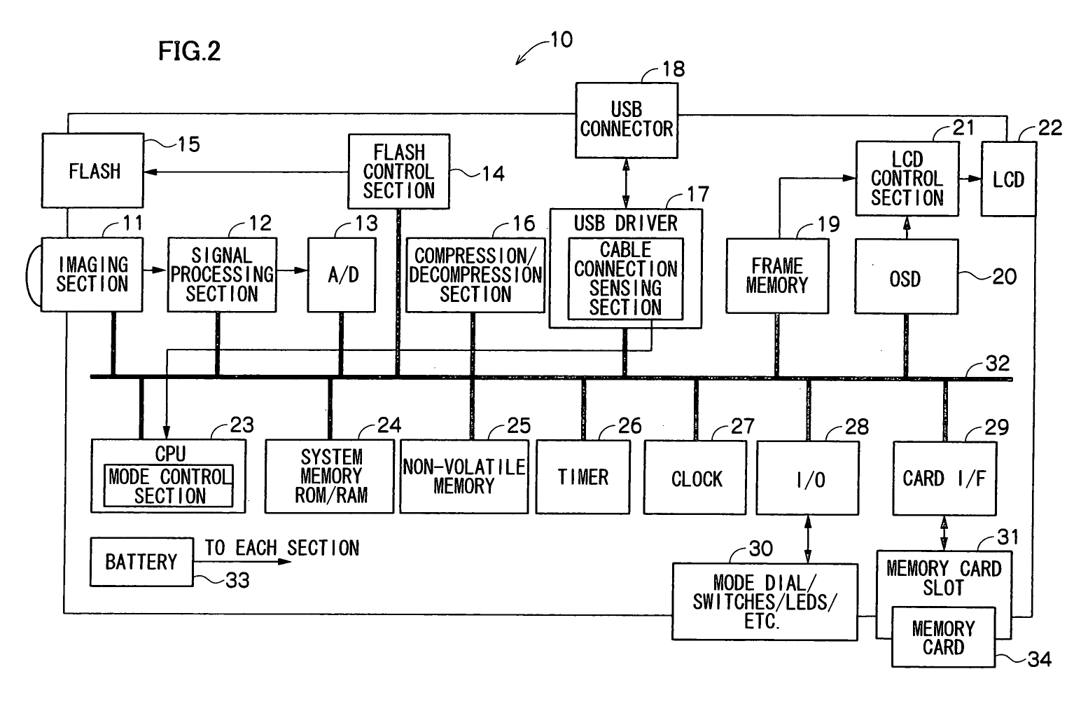

Next, structure of a control system of the digital camera 10 will be described with reference to FIG. 2. As is shown in FIG. 2, this digital camera 10 has a structure the same as ordinary digital cameras which are currently in wide circulation.

An imaging section 11 is provided in the digital camera 10. The imaging section 11 is provided with a lens, a mechanical shutter, an iris and a CCD (not shown). Imaging of a subject is performed by light which enters through the lens being incident at a light-receiving surface of the CCD, via the iris, when the mechanical shutter is open, and the light that is incident at and focused on the light-receiving surface of the CCD being converted to electronic charges in accordance with received light amounts and accumulated by individual photoelectric conversion cells.

A flash 15 is also provided at the digital camera 10. When required, the flash 15 is manually or automatically caused to emit light, in accordance with control by a flash control section 14.

Respective control devices of the digital camera 10, including the imaging section 11 and the flash control section 14, are connected by a bus 32, and operations thereof are controlled by a CPU 23. The CPU 23 executes a program memorized in a non-volatile memory 25, which will be described later, and thus implements various types of control, including control of switching between operation modes of the digital camera. Herein, the various control devices are supplied with power from a battery 33 for operation.

This digital camera 10 has a plurality of operation modes, and the CPU 23 switches between the operation modes in accordance with a mode dial of a control/display section 30 or pressing of a data transfer button 57b, which will be described later. The operation modes include a photography mode for photographing subjects and a replay mode for replaying captured subject images, and an additional USB mass storage mode for transferring image data obtained by photography to the image distribution server 40. The USB mass storage mode is a mode in which the digital camera 10 operates as a storage device for an external device (here, the image distribution server 40) which is connected to a later-described USB connector 18.

As control devices, the CPU 23, a system memory (RAM and ROM or the like) 24, a non-volatile memory 25, a timer function section 26 and a date/time function section 27 are respectively connected to the bus 32.

An I/O port 28 is also connected to the bus 32. The I/O port 28 is connected to the control/display section 30 and functions as an input/output interface for the control/display section 30. The control/display section 30 is mounted at the casing of the digital camera 10 and includes a mode dial, various operation switches (for example, a shutter-release button, a power switch and so forth), LEDs and the like.

A memory card slot 31 is also connected to the bus 32, via a card I/F (interface) 29. A memory card 34 is set in the memory card slot 31 to serve as a storage section. The memory card 34 is removable from the memory card slot 31, and image data which is photographed by the imaging section 11 is recorded at the memory card 34 that is set in the memory card slot 31. The storage section which stores image data is not limited to the memory card 34. For example, it is possible to provide a memory with a capacity large enough to memorize image data in the digital camera and to memorize image data at that memory.

Signals outputted from the imaging section 11 are inputted to a signal processing section 12, noise reduction processing such as correlated double sampling or the like is applied, gain control is implemented, and the signals are outputted to an A/D conversion section 13.

In accordance with instructions from the CPU 23, image data which has been A/D-converted at the A/D conversion section 13 is sent to a compression/decompression section 16, subjected to compression processing, and sent to the memory card slot 31 via the card I/F 29.

In response to a replay display instruction from the CPU 23, image data which has been recorded to the memory card 34 is read out and held in a frame memory 19, and displayed at an LCD 22 in accordance with control of an LCD control section 21. At such a time, an image display, based on image data obtained by photography at the imaging section 11, and texts, character data and the like are superimposed by an OSD (on-screen display) circuit 20 for display at the LCD 22.

Now, a USB driver 17 is connected to the bus 32. The USB driver 17 is a structure which is directly connected with an external device via a USB connector 18, and which can implement communications in conformance with USB standards. The digital camera 10 carries out USB communications with an external device (for example, the image distribution server 40) with which the digital camera 10 is connected by a USB cable via the USB connector 18.

The USB driver 17 features a sensing function for sensing connection when a USB cable is connected. More specifically, a USB cable is structured with a power line for supplying electric power and a signal line for sending and receiving data signals. The USB driver 17 implements USB cable connection verification in accordance with detection of the presence or absence of electric power provision along the power line of a USB cable (i.e., the presence or absence of USB bus power), judges that the USB cable is connected when the provision of electric power is sensed (i.e., USB bus power is on), and outputs sensing results to the CPU 23.

Accordingly, the CPU 23 switches from an operation mode that is currently in effect to the USB mass storage mode. While the USB bus power-on state continues, the USB mass storage mode continues. Then, when a stoppage of the electric power provision is sensed (i.e., the USB bus power is off), this sensing result is outputted to the CPU 23. Accordingly, the CPU 23 switches back to the operation mode that was in effect prior to switching to the USB mass storage mode (or to a preset operation mode).

Thus, because the function for sensing connection of a USB cable detects USB bus power, it is possible to appropriately switch between operation modes in a state in which the image distribution server 40 stays connected with the USB cable, by the USB bus power being controlled to turn on and off by the image distribution server 40. The image distribution server 40 of the present embodiment controls the USB power to turn on and off (as will be described in more detail later) while remaining connected to the digital camera 10 with the USB cable. Therefore, the digital camera 10 can be carried around in a state of being connected to the image distribution server 40, and can be switched to appropriate operating modes for use.

The image distribution server 40 which is connected to the digital camera 10 has a substantial box shape. The exterior of the image distribution server 40 is shown in FIG. 1, viewed from a rear face thereof. As shown in FIG. 1, a power button 57a and the data transfer button 57b are provided at a side face of the image distribution server 40. The power button 57a turns power and off, and the data transfer button 57b is for acquiring image data that has been memorized in the digital camera 10. A USB connector 46 for external storage is provided at a rear face of the image distribution server 40. The USB connector 46 is a connector conforming to USB standards. The image distribution server 40 is connected to the digital camera 10 through this USB connector 46 and acquires image data that has been memorized in the digital camera 10 by means of USB communications.

The image distribution server 40 is a structure capable of wireless LAN communications. The image distribution server 40 connects with a base station 64 provided on a network 66 by wireless LAN communications, and thus can communicate with various computer terminals (the PC 60, the PDA 62 and the like).

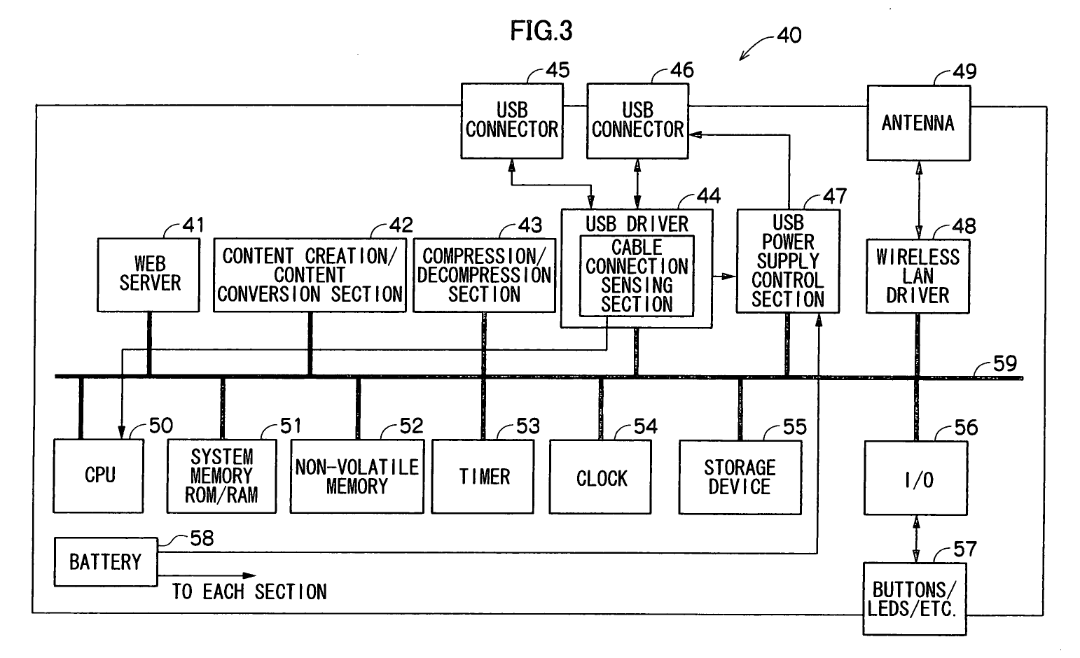

Herebelow, structure of a control system of the image distribution server 40 will be described with reference to FIG. 3.

The image distribution server 40 is provided with a Web server section 41 and a content creation/conversion section 42, which are respectively connected to a bus 59. The Web server section 41 executes functions of a Web server, for exhibiting (distributing) content when a distribution request is received by a wireless LAN driver 48, which will be described later, from an image display browser at a client terminal by means of wireless LAN communications. The content creation/conversion section 42 creates content (a Web page) for exhibition over the Web, and converts the image data to a predetermined format for inclusion in the Web page.

As control devices, a CPU 50, system memory (RAM and ROM or the like) 51, a non-volatile memory 52, a timer function section 53 and a date/time function section 54 are respectively connected to the bus 59.

The CPU 50 executes a program which has been memorized in the non-volatile memory 52 or a later-described storage device 55, and thus implements various kinds of control of the image distribution server 40 as a whole, including control when acquiring and distributing image data from the digital camera 10, and the like.

An I/O port 56 is also connected to the bus 59. This I/O port 56 is connected to a control/display section 57, which includes input buttons (the aforementioned power button 57a, data transfer button 57b and the like), LEDs and the like which are provided at the image distribution server 40, and functions as an input/output interface of the control/display section 57.

The storage device 55 is also connected to the bus 59. The storage device 55 is structured with, for example, a hard disk drive (HDD) or the like, and memorizes image data acquired from the digital camera 10. Because the image data acquired from the digital camera 10 is in a compressed state, when image data memorized in the storage device 55 is to be read out and exhibited on the Web, the image data in the compressed state is sent to a compression/decompression section 43, and is decompressed and sent to the content creation/conversion section 42. The content creation/conversion section 42 performs processing to convert this decompressed image data to a predetermined format for inclusion in a Web page, or the like, and then creates data for the Web page on the basis of the image data.

A memorization location for image data acquired from the digital camera 10 is not limited to an internal storage device or the storage device 55 and can, for example, be saved at a storage device such as an external HDD (not shown) or the like that is connected to a later-described USB connector 45.

A USB driver 44 is also connected to the bus 59. The USB driver 44 is a structure capable of directly connecting with external devices via the USB connectors 45 and 46 and implementing communications conforming to USB standards. The image distribution server 40 carries out USB communications with external devices connected to the image distribution server 40 (for example, the digital camera 10) by means of USB cables via the USB connectors 45 and 46.

Now, one of the two USB connectors, the USB connector 46, is connected to a USB power supply control section 47. The USB power supply control section 47 implements provision of power (USB bus power) to the USB connector 46 by control of the USB driver 44. The provision of the USB bus power commences when the aforementioned data transfer button 57b is set to On by a user. More specifically, when the fact of the data transfer button 57b being set to On is propagated to the CPU 50 via the I/O port 56, an instruction to turn the USB bus power on is outputted from the CPU 50 to the USB driver 44. Accordingly, the USB driver 44 outputs an On instruction to the USB power supply control section 47, and the provision of USB bus power to the USB connector 46 commences. The USB bus power is provided to the power line of the USB cable connected to the USB connector 46, and is outputted to the digital camera 10.

Then, when the acquisition of all image data from the digital camera 10 has been completed, an instruction to turn the USB power off is outputted from the CPU 50 to the USB driver 44. Accordingly, the USB driver 44 outputs an Off instruction to the USB power supply control section 47, and the provision of the USB bus power to the USB connector 46 is stopped.

Further still, the wireless LAN driver 48 is connected to the bus 59. The wireless LAN driver 48 is connected to an antenna 49, and is a structure capable of wireless LAN communications with the external network 66. By such wireless LAN communications, the Web server section 41 can receive image distribution requests from image display browsers of the PC 60, the PDA 62 and the like and can distribute data for Web display of Web pages in response to the received distribution requests.

Electric power is supplied from a battery 58 to the control devices connected to the bus 59 to enable operations thereof.

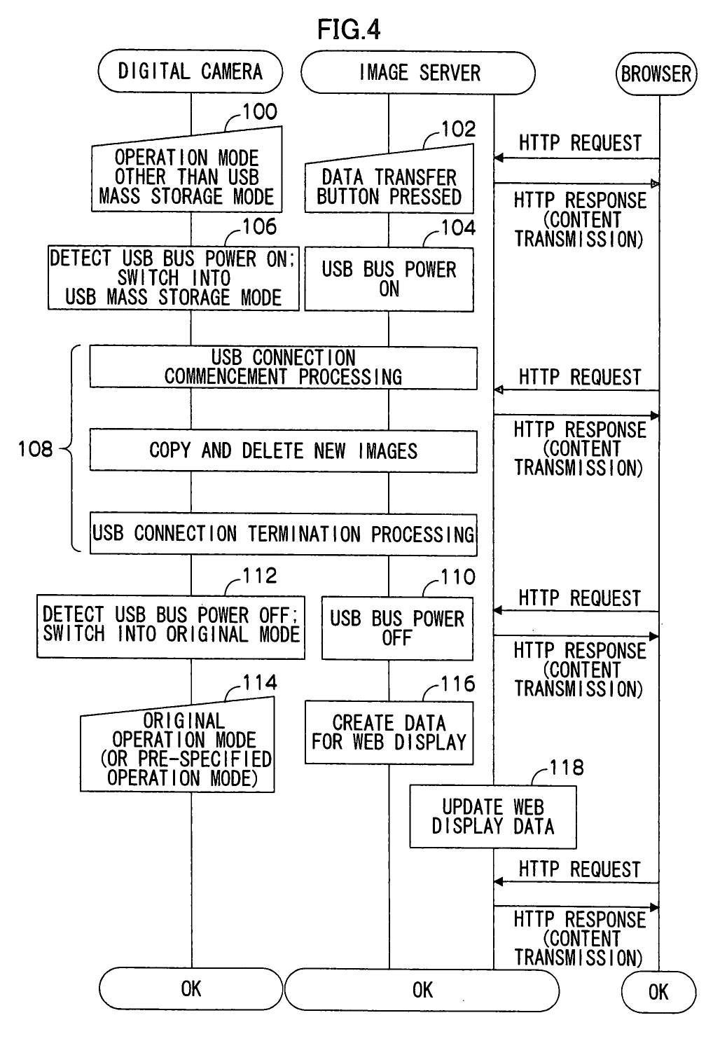

FIG. 4 is a flowchart showing a flow of operations of the present image viewing system 1.

Firstly, with the USB connector 18 of the digital camera 10 and the USB connector 46 of the image distribution server 40 having been connected by a USB cable, if a user presses the data transfer button 57b (step 102) during photography by the photography mode, during replay in the replay mode or the like (step 100), then in accordance with instructions from the CPU 50, the USB driver 44 outputs an instruction to the USB power supply control section 47 to turn on the USB bus power. Accordingly, the provision of USB bus power to the USB connector 46 commences (step 104).

When the digital camera 10 senses the USB bus power being on, the operation mode of the digital camera 10 is switched, by control from the CPU 23, from the operation mode that was previously in effect to the USB mass storage mode. Hence, as mass storage, USB connection commencement processing is commenced and a USB connection is established between the digital camera 10 and the image distribution server 40. Then, processing for transfer of the image data from the memory card 34 of the digital camera 10 to the storage device 55 of the image distribution server 40 is implemented by communications conforming to USB standards (i.e., USB communications) (step 108).

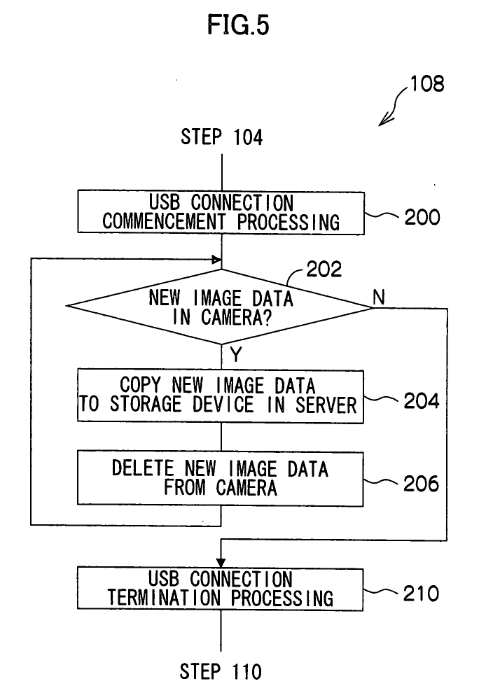

FIG. 5 is a flowchart showing the processing of step 108 at the image distribution server 40 in detail.

In step 200, the USB connection commencement processing is carried out by the CPU 50 and the USB driver 44. Here, a usual procedure for commencing a USB connection is performed.

In step 202, the CPU 50 of the image distribution server 40 establishes whether or not new image data has been recorded in the memory card 34 of the digital camera 10. If so, in step 204 the image data is copied to the storage device 55 in the image distribution server 40, in step 206 the image data that has been copied is deleted from the memory card 34 of the digital camera 10, and then the processing returns to step 202.

On the other hand, when it is determined in step 202 that there is no new image data recorded in the memory card 34 of the digital camera 10, the processing advances to step 210 and USB connection termination processing is carried out. Here, a usual procedure for closing a USB connection is performed.

Then, in step 110 of FIG. 4, the image distribution server 40 outputs an instruction to turn USB bus power off to the USB power supply control section 47, and the provision of the USB bus power to the USB connector 46 is stopped.

When the digital camera 10 senses that the USB bus power is off (step 112), the operation mode of the digital camera 10 is switched, by control from the CPU 23, from the USB mass storage mode previously in effect to the operation mode that was in effect prior to switching to the USB mass storage mode (or to a preset operation mode). Thereafter, until the data transfer button 57b of the image distribution server 40 is pressed, that operation mode or an operation mode that a user selects with the mode dial will be in effect (step 114).

Meanwhile, at the image distribution server 40, in accordance with instructions from the CPU 50, the content creation/conversion section 42 carries out processing for creation of data for browser display (HTML data creation, thumbnail creation and the like) on the basis of the acquired image data (step 116), and updates the data for Web display (step 118). Hence, when an image display browser of a client terminal outputs an image distribution request (an HTTP request), the new image(s) can be viewed.

As shown in FIG. 4, in response to an HTTP request which is received in the background via wireless LAN communications from an image display browser of the PC 60, the PDA 62 or the like during the above-described image data acquisition, the image distribution server 40 distributes content (Web display data and image data) via the wireless LAN communications (an HTTP response). However, until the processing of step 118 is complete, non-updated Web display data and image data is distributed.

Then, after the Web display data has been updated in step 118 after the acquisition of image data, the image distribution server 40 can distribute data including up-to-date image data in response to HTTP requests.

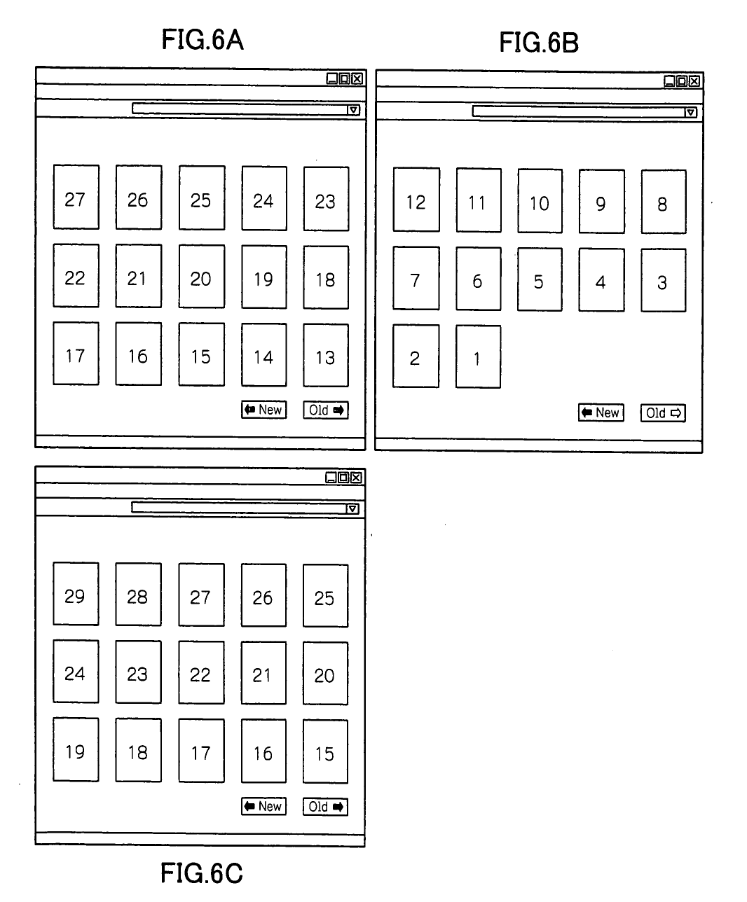

FIGS. 6A to 6C are views showing examples of image list Web pages, which are displayed in an image display browser of a client terminal such as the PC 60, the PDA 62 or the like.

FIG. 6A is a first page, and shows images of image data of Nos. 13 to 27 acquired from the digital camera 10. FIG. 6B is a second page and shows images of image data of Nos. 1 to 12. Here, the Web page is created so as to display the most recently photographed images on the first page. The most recently created images have larger numbers in FIGS. 6A to 6C. As shown in FIGS. 6A to 6C, respective Web pages in a sequence can be viewed using a “New” button and an “Old” button at the lower side of the screen.

After image data has been acquired from the digital camera 10 and the Web display data has been updated as described above, when a user clicks on an update button (not shown) of the image display browser, a Web page in which the image list is updated is displayed, as shown in FIG. 6C. In FIG. 6C, images of new image data of Nos. 28 and 29 are additionally displayed.

A function which updates a Web page automatically even if a user does not click on the update button (an automatic update function) can be included in and distributed with the Web display data for displaying the Web page.

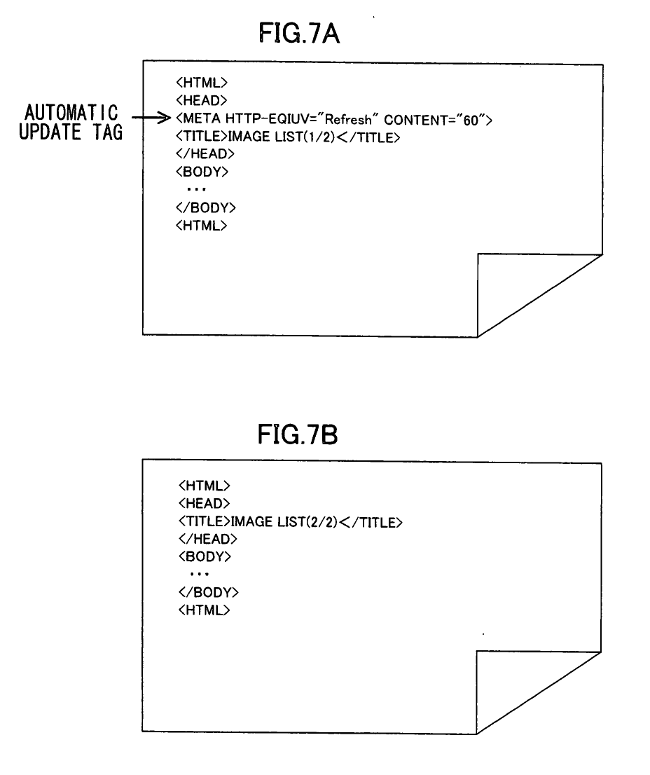

If, for example, this automatic update function is added only to the first page, which displays the most recent images, but is not added to subsequent pages, then Web display data (HTML data) of the first page can be described as shown in FIG. 7A, and a next and subsequent pages can be described as shown in FIG. 7B.

In the Web display data of the first page that is shown in FIG. 7A, as indicated by the arrow, an automatic update tag:

<META HTTP-EQUIV=“Refresh” CONTENT=“60” >

is added. An automatic update instruction and automatic update period (60 seconds) are specified by this tag. When the Web page which the Web display data that includes this tag is viewed, the image display browser performs update processing at 60-second intervals (that is, performs HTTP requests at 60-second intervals) in accordance with this tag. Thus, automatic updating without the update button being clicked is implemented.

With FIG. 7B, because the automatic update tag is not included, automatic updating is not performed.

The automatic update function is not added except at the first page in this manner because when a page which a user is viewing is a page entirely of older images (meaning it is not the first page), the user can choose and determine the older images that are being viewed, and removing the images that are being reviewed from such a page in an automatic update will often be confusing for users. Therefore, it is preferable to not add the automatic update tag thereto. Of course, depending on system specifications, user objectives and the like, the automatic update function could be added to all pages.

It is also possible for the image distribution server 40 to calculate and set the automatic update interval automatically on the basis of (a) predetermined variable(s).

For example, in order to prevent wasteful automatic updating, various setting methods can be employed, such as:

(1) An average time interval with which the data transfer button 57b has been operated hitherto is taken as a reference, and a slightly longer period than this is set;

(2) When update processing according to the automatic update tag has been performed but there has been no recent image data at the digital camera 10 (that is, a photography interval is long and a photography frequency is low), a longer period is specified as the automatic update interval;

(3) when it is sensed that the USB cable connection with the digital camera 10 has been broken, the automatic update tag is not added;

and so forth.

Further, for example, in order to avoid increasing loads on the image distribution server 40, a setting method may be employed such that:

(4) A frequency of HTTP requests to the image distribution server 40 and an average processing period of requests are taken as references, and the automatic update interval is specified such that a ratio of an expected average number of clients to a number of clients that the image distribution server is capable of processing simultaneously does not exceed a certain value.

Further again, in a case of varying the automatic update interval in correspondence with individual client terminals that make image distribution requests (HTTP requests), client terminals are distinguished and application of the benefits of automatic updating can be limited by:

(5) For an HTTP request from a client terminal which has not been previously registered with the image distribution server 40, Web display data in which the automatic update tag is not added or in which the automatic update interval is set to be long is distributed;

(6) For an HTTP request from a client terminal on a different subnet from the image distribution server 40, Web display data is distributed in which the automatic update tag is not added or in which the automatic update interval is set to be long;

or the like.

Further yet, in consideration of congestion of the network 66, a setting method can be employed which:

(7) Provides detecting means at the image distribution server 40 for detecting congestion of the network 66, sets the automatic updating interval to be long if the detected congestion is high, and sets the automatic update interval to be short if the congestion is low.

Anyway, it is also possible to perform acquisition of image data at a time of start-up of the image distribution server 40. That is, when the power button 57a of the image distribution server 40 is pressed, similarly to an acquisition request for image data, image data is acquired from the digital camera 10 contemporaneously with initialization processing at the time of start-up of the image distribution server 40.

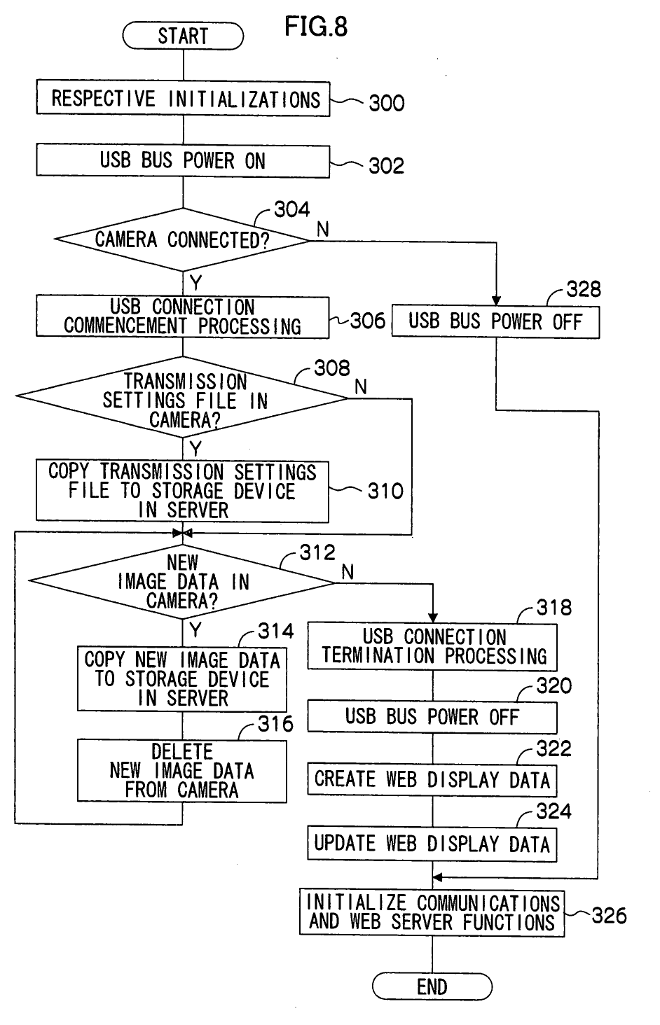

FIG. 8 is a flowchart showing a flow of operations of the image distribution server 40 at the time of start-up.

When the power button 57a is pressed, in step 300, initialization of settings data and the like of the image distribution server 40 is carried out.

In step 302, in the same manner as described earlier, the provision of USB bus power to the USB connector 46 is commenced.

In step 304, it is determined whether or not the digital camera 10 is connected to the USB connector 46 via a USB cable. This determination is performed by checking a state of conduction with respect to output of the USB bus power.

If the digital camera 10 is connected to the USB connector 46, the operation of the digital camera 10 is switched to the USB mass storage mode in accordance with the provision of the USB bus power. Accordingly, the image distribution server 40 can access the digital camera 10 which serves as a storage device connected to the USB connector 46.

If it has been judged in step 304 that the digital camera 10 is connected, USB connection commencement processing is carried out in step 306.

In step 308, it is determined whether a transmission settings file has been stored at the digital camera 10. A transmission settings file is a file relating to transmission settings which are applied when the digital camera 10 and the image distribution server 40 are connected by the USB cable and performing data transfer. When such a transmission settings file is installed, information of various settings for data transfer to the image distribution server 40, a driver and the like are incorporated therein.

If it is determined in step 308 that a transmission settings file has been memorized at the digital camera 10, then in step 310, the transmission settings file is read and copied to the storage device 55 in the image distribution server 40, and the processing advances to step 312.

On the other hand, if it is determined in step 308 that a transmission settings file is not memorized at the digital camera 10, then the processing of step 310 is skipped and the processing advances to step 312. In such a case, in which it is not possible to copy a transmission settings file, a general-purpose transmission settings file which has been memorized at the image distribution server 40 beforehand is utilized.

In step 312, it is established whether or not newly recorded image data is present in the memory card 34 of the digital camera 10. If so, in step 314, the image data is copied to the storage device 55 in the image distribution server 40. In step 316, the image data that has been copied is deleted from the memory card 34 of the digital camera 10, and the processing returns to step 312.

On the other hand, when it is determined in step 312 that there is no newly recorded image data in the memory card 34 of the digital camera 10, the processing advances to step 318 and USB connection termination processing is carried out.

Thereafter, in step 320, the provision of the USB bus power to the USB connector 46 is ended.

Here, when the digital camera 10 establishes that the USB bus power is off, the operation mode of the digital camera 10 switches from the USB mass storage mode that has been in effect hitherto to the previous operation mode that was in effect prior to switching to the USB mass storage mode (or to the preset operation mode).

At the image distribution server 40, in step 322, in accordance with instructions from the CPU 50, the content creation/conversion section 42 carries out data creation processing for browser display (HTML data creation, thumbnail creation and the like) based on the image data that has been acquired. Then, in step 324, the Web display data is updated, and the processing advances to step 326.

Meanwhile, if it is determined in step 304 that the digital camera 10 is not connected, the above-described processing of steps 306 to 324 is skipped, and the processing advances to step 326.

In step 326, a transmission function is initialized on the basis of the above-acquired transmission settings file or the general-purpose transmission settings file, a Web server function is initialized, and this processing for the time of start-up ends.

For the embodiment described above, an example has been described in which image data is acquired from the digital camera 10 when the data transfer button 57b or the power button 57a of the image distribution server 40 is pressed. However, this is not a limitation. It is also possible for the image distribution server 40 to acquire image data from the digital camera 10 having received a request from an image display browser of a client terminal such as the PC 60, the PDA 62 or the like.

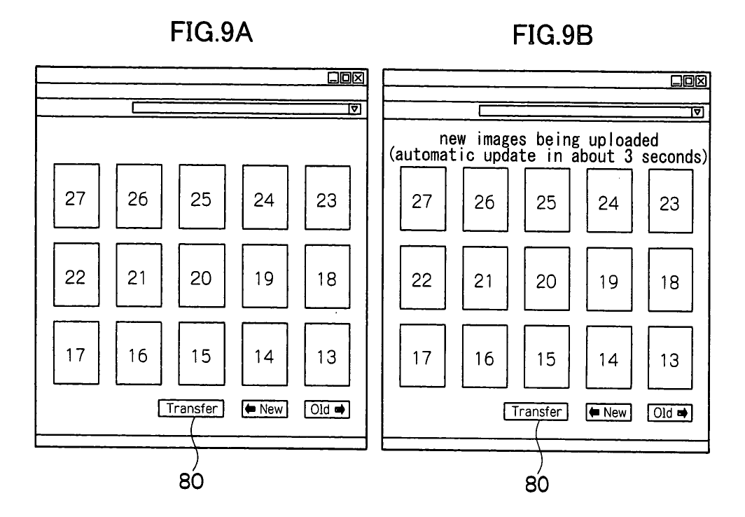

Firstly, the image distribution server 40 creates Web display data for displaying a Web page for image viewing as shown in FIG. 9A, and distributes the data to the image display browser.

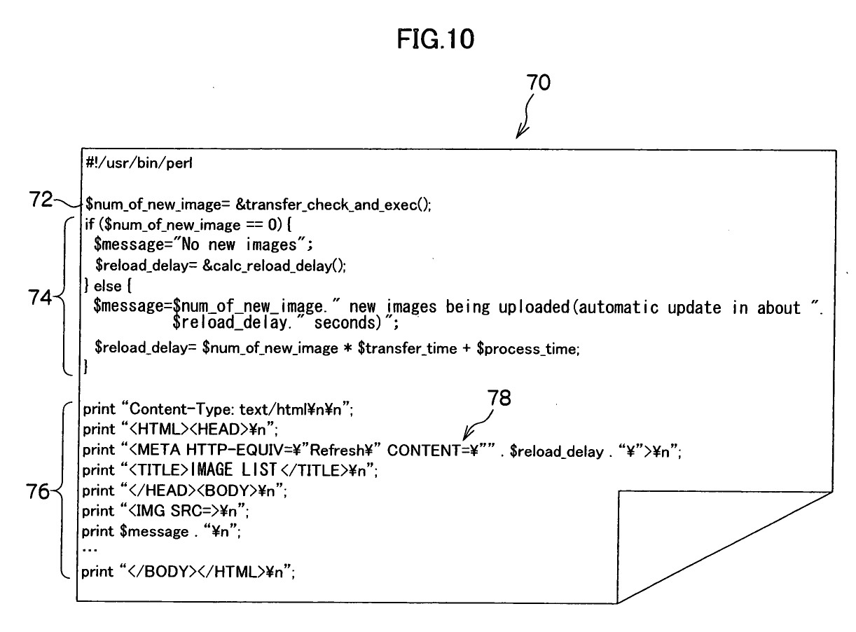

As shown in FIG. 9A, a “transfer” button 80 is provided at the lower side of the Web page for image viewing. When a user clicks on this “transfer” button 80, a “transfer.cgi” script 70 shown in FIG. 10 is launched by the image distribution server 40.

The following processing is executed by this cgi script.

Firstly, in accordance with a description 72 of the transfer.cgi script 70, a “transfer_check_and_exec” function is executed in order to check a number of new images at the memory card 34 of the digital camera 10 (i.e., a number of new image data sets).

When the number of new images is obtained by execution of the transfer_check_and_exec function, in accordance with a description 74, a message (i.e., a $message variable) is specified in respective response to a case in which there are new images (i.e., when there is at least one set of image data of images which have been newly photographed) and a case in which there are no new images (i.e., when there are zero sets of image data of newly photographed images).

The description 74 also specifies an automatic update interval for the image display browser (i.e., a $reload_delay variable).

If there are new images, the automatic update interval is calculated from {number of new images×reading time per image+Web display data creation & update time}. The number of new images has been acquired by the transfer_check_and_exec function of the description 72, the reading time per image has been specified beforehand by a $transfer_time variable, and the Web display data creation/update time has been specified beforehand by a $process_time variable.

That is, in this case, reloads are automatically performed each time the image distribution server 40 acquires individual sets of image data from the digital camera 10.

On the other hand, if there are no new images, for the automatic update interval, an automatic update interval calculated by a calc_reload_delay function is specified. This calc_reload_delay function specifies the interval by, for example, calculating as with the earlier-mentioned automatic update interval specification methods (1) to (7) or the like.

After the automatic update interval has been specified thus, details of the Web page are outputted in accordance with a description 76 of the transfer.cgi script 70. An automatic update tag 78 is included in the description 76. With this automatic update tag 78, details of the Web page are automatically reloaded at the automatic update interval (i.e., the $reload_delay variable) that has been specified by the description 74.

According to this cgi script, when there are no new images at the digital camera 10, a message “No new images” is displayed, and when there are new images, the Web page is displayed at the image display browser with the message “XX new images being uploaded (automatic update in YY seconds)” added (for example, see FIG. 9B).

Next, operations of the transfer_check_and_exec function which is called from the transfer.cgi script 70 will be described.

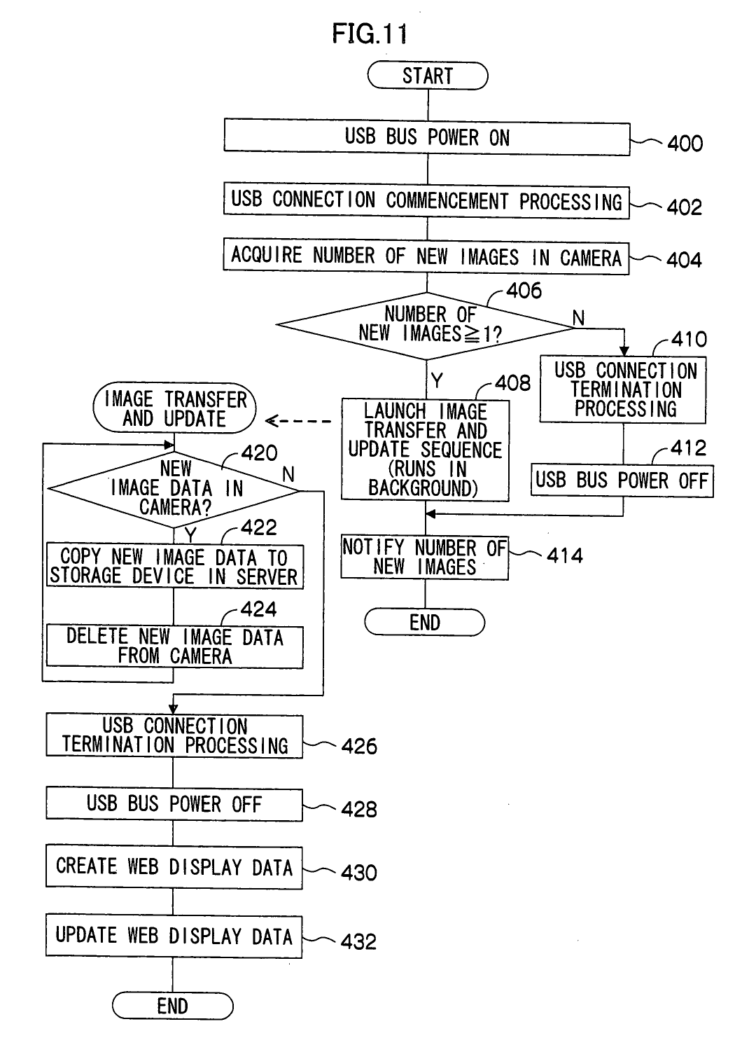

FIG. 11 is a flowchart showing a flow of processing of the transfer_check_and_exec function (the description 72 of FIG. 10) which is executed by the image distribution server 40.

In step 400, the provision of USB bus power to the USB connector 46 is commenced. When the digital camera 10 senses that the USB bus power is on, in accordance with control from the CPU 23, the operation mode of the digital camera 10 is switched from the operation mode previously in effect to the USB mass storage mode.

In step 402, the USB connection commencement processing is carried out by the CPU 50 and the USB driver 44.

In step 404, the CPU 50 of the image distribution server 40 establishes whether or not image data has been newly recorded in the memory card 34 of the digital camera 10, and if so, counts the number of sets of image data (i.e., the number of new images).

In step 406, it is determined whether or not the number of new images is at least one. If the number of new images is one or more, the processing advances to step 408, and an image transfer and update sequence is launched and is executed in the background.

The image transfer and update sequence is shown in steps 420 to 432 of FIG. 11. The processing that is carried out in these steps is similar to the processing shown in steps 202 to 210 of FIG. 5 and steps 110, 116 and 118 of FIG. 4, and therefore will not be described here.

On the other hand, if it is determined in step 406 that the number of new images is zero, the processing advances to step 410, the USB connection termination processing is performed, and in step 412 the USB bus power is turned off.

After the processing of step 408 or step 412, the processing advances to step 414, and the number of new images that was acquired in step 404 is notified to the transfer.cgi script 70, which is a main program.

Thereafter, the description 74 and the description 76 of the transfer.cgi script 70 are executed. Here, if the number of new images is one or more, then because the above-mentioned image transfer and update sequence is operating in the background, the Web page is displayed with the message that new images are being acquired being shown, and the Web page will be automatically updated in accordance with the acquisition of the image data at the calculated and specified automatic update interval.

Now, in this case, because the image transfer and update sequence is divided into a separate process from the transfer_check_and_exec function, even if a large number of new images have been accumulated at the digital camera 10, a situation in which a long time is spent on the processing so the image display browser is in a transfer-waiting state and operation thereof stops can be avoided.

For the above embodiment, it has been described that the image distribution server 40 outputs USB bus power to the power line to serve as a switching signal for switching the operation mode of the digital camera 10 to the mass storage mode. However, the present invention is not limited thus. For example, it is also possible to output a pre-specified switching signal on the signal line.

Further, the above embodiment has been described with the USB mass storage class being employed as a USB communications standard that the digital camera 10 employs at the time of mass storage operations. However, this is not a limitation. It is also possible to use other standards (for example, a PTP standard employing the USB still image class or the like).

Further, for the above embodiment, an example has been described in which the digital camera 10 and the image distribution server 40 are connected using USB connectors and a USB cable. However, this is not a limitation. It is also possible to use connectors and cables for implementing communications in conformance with other standards (for example, IEEE1394 or the like).

Further, for the above embodiment, an example has been described in which the image distribution server 40 continues output of the USB bus power as the switching signal while image data is being acquired. However, this is not a limitation. For example, it is possible to continue the output of USB bus power from commencement of the output of USB bus power until there is a request to stop the output of USB bus power from outside (for example, the data transfer button 57b being switched off).

Further, for the above embodiment, an example has been described in which the image distribution server 40 switches the operation mode of the digital camera 10 by turning the USB bus power on and off. However, the present invention is not limited thus. For example, it is possible to output a predetermined cancellation signal to the signal line to cancel the mass storage mode when the acquisition of image data has finished or when there is a request to stop the output of USB bus power from outside (for example, when the data transfer button 57b is switched off). If the digital camera 10 is set so as to switch from the mass storage mode to a pre-specified operation mode when the cancellation signal is inputted, it is possible to appropriately switch between operation modes.

Further, for the above embodiment, an example has been described of commencing provision of USB bus power and switching the digital camera 10 to the mass storage mode in accordance with pushing of the data transfer button 57b. However, it is also possible to provide a continuous power supply voltage from the image distribution server 40 to the USB cable and switch the operation mode of the digital camera 10 when the USB cable is inserted/removed.

Further, the above embodiment has been described for an example in which the digital camera 10 serves as the image storage device. However, this not a limitation. For example, storage devices such as portable hard disk devices are also possible.

Furthermore, wireless communications which are employed for HTTP requests and HTTP responses are not limited to the above-mentioned wireless LAN communications. For example, communications employing PHS or the like are also possible.

An embodiment of the present invention is described above, but the present invention is not limited to the embodiment as will be clear to those skilled in the art.

Namely, according to a first aspect of the invention, there is provided an image distribution system comprising: an image storage device including a storage section which stores image data, the image storage device switching to a mass storage mode when a switching signal is inputted; and an image distribution server which outputs the switching signal to the image storage device when there is a request from an external section, acquires the image data from the storage section of the image storage device which has switched to the mass storage mode, and distributes the acquired image data in response to a request from an image display browser.

In the system of this aspect, when there is a request from the external section, the switching signal is outputted to the image storage device, the image storage device is switched to the mass storage mode, and the image data is acquired and distributed. Therefore, it is possible to switch the operation mode of the image storage device and acquire the image data under the guidance of the image distribution server, rather than providing a dedicated function at the image storage device. Therefore, the image data can be acquired from the image storage device simply and reliably without complex control, and images of the acquired image data can be seen via an image display browser installed at a PC or the like.

The mass storage mode is a mode in which the image storage device operates as a storage device of the image distribution server.

The image distribution server may continue output of the switching signal during acquisition of the image data or from commencement of output of the switching signal until there is a request from the external section to stop output of the switching signal, and, after switching to the mass storage mode, the image storage device may switch from the mass storage mode to a pre-specified operation mode when the switching signal ceases to be inputted.

While output of the switching signal continues, the mass storage mode of the image storage device continues. Therefore, the image data can be stably acquired. Furthermore, if the connection of the image storage device with the image distribution server is implemented by a cable, it is possible to switch the operation mode of the image storage device without inserting/removing the cable. Therefore, users will not be inconvenienced and there will be fewer problems with connectors.

The pre-specified operation mode here may be, for example, the operation mode that was in effect before switching to the mass storage mode, and may be a preset operation mode.

When the image distribution server has finished acquiring the image data or when there is a request from the external section, the image distribution server may output a cancellation signal for canceling the mass storage mode, and, when the cancellation signal is inputted, the image storage device may switch from the mass storage mode to a pre-specified operation mode.

Because the mass storage mode of the image storage device continues until the cancellation signal is outputted, the image data can be stably acquired. Furthermore, if the connection of the image storage device with the image distribution server is implemented by a cable, it is possible to switch the operation mode of the image storage device without inserting/removing the cable. Therefore, users will not be inconvenienced and there will be fewer problems with connectors.

The image distribution server may acquire the image data by communications conforming to a USB standard, and output USB bus power as the switching signal, and the image storage device may switch to the mass storage mode when the USB bus power is inputted.

The image data is acquired using communications conforming with the USB standard, and the USB bus power is utilized as the switching signal. Therefore, the power line can be used as a signal line for the switching signal, and it is not necessary to prepare signal lines of two categories: a signal line for image data communications and a signal line for the switching signal. Further, because the USB bus power is not outputted when the mass storage mode is not being used, a saving of energy is possible. Furthermore, because the operation mode of the image storage device can be switched by the USB bus power being turned on and off rather than the USB cable being inserted and removed, users will not be inconvenienced, there will be fewer problems with connectors, and ordinary USB equipment can be used without modification.

The USB bus power here refers to provided electrical power (a power supply voltage) when a power supply that is provided through a USB cable is employed to operate a peripheral device.

When the image distribution server is to distribute the image data, the image distribution server may create distribution data for causing the image display browser to request distribution of the image data at a predetermined time interval, and distribute the distribution data with the image data.

Thus, because the image display browser updates the image data automatically at the predetermined time interval while the image data is being viewed, there is no need for manual update requests by a user, and convenience is improved.

In such a case, the image distribution server may set the predetermined time and create the distribution data in accordance with at least one of: an interval or frequency of input of the image data to the image storage device, an interval or frequency of input of the switching request, an interval or frequency of requests for image data from the image display browser, congestion of a distribution path when distributing the image data, or an identification number identifying a client at which the image display browser is installed.

The image distribution server may both receive the request from the image display browser and distribute the image data by wireless communications.

Accordingly, such an image distribution server can be portably moved.

The image storage device may include a digital camera or a portable hard disk device. According to a second aspect of the invention, there is provided an image distribution server wherein the image distribution server is connectable with an image storage device including a storage section which stores image data, the image storage device switching to a mass storage mode when a switching signal is inputted, and the image distribution server outputs the switching signal to the image storage device when there is a request from an external section, acquires image data from the storage section of the image storage device which has switched to the mass storage mode, and distributes the acquired image data in response to a request from an image display browser.

With the image distribution server of this aspect, it is possible to switch the operation mode of the image storage device and acquire the image data under the guidance of the image distribution server, rather than providing a dedicated function at the image storage device. Therefore, the image data can be acquired from the image storage device simply and reliably without complex control, and images of the acquired image data can be seen via an image display browser installed at a PC or the like.

The image distribution server may continue output of the switching signal so as to maintain the mass storage mode of the image storage device during acquisition of the image data or from commencement of output of the switching signal until there is a request from the external section to stop output of the switching signal.

While output of the switching signal continues, the mass storage mode of the image storage device continues. Therefore, the image data can be stably acquired. Furthermore, if the connection of the image storage device with the image distribution server is implemented by a cable, it is possible to switch the operation mode of the image storage device without inserting/removing the cable. Therefore, users will not be inconvenienced and there will be fewer problems with connectors.

When the image distribution server has finished acquiring the image data or when there is a request from the external section, the image distribution server may output a cancellation signal to the image storage device for canceling the mass storage mode.

Because the mass storage mode of the image storage device continues until the cancellation signal is outputted, the image data can be stably acquired. Furthermore, if the connection of the image storage device with the image distribution server is implemented by a cable, it is possible to switch the operation mode of the image storage device without inserting/removing the cable. Therefore, users will not be inconvenienced and there will be fewer problems with connectors.

The image distribution server may acquire the image data by communications conforming to a USB standard, and output USB bus power as the switching signal.

The image data is acquired using communications conforming with the USB standard, and the USB bus power is utilized as the switching signal. Therefore, the power line can be used as a signal line for the switching signal, and it is not necessary to prepare signal lines of two categories: a signal line for image data communications and a signal line for the switching signal. Further, because the USB bus power is not outputted when the mass storage mode is not being used, a saving of energy is possible. Furthermore, because the operation mode of the image storage device can be switched by the USB bus power being turned on and off rather than the USB cable being inserted and removed, users will not be inconvenienced, there will be fewer problems with connectors, and ordinary USB equipment can be used without modification.

When the image distribution server is to distribute the acquired image data, the image distribution server may create distribution data for causing the image display browser to request distribution of the image data at a predetermined time interval, and distribute the distribution data with the image data.

Thus, because the image display browser updates the image data automatically at the predetermined time interval while the image data is being viewed, there is no need for manual update requests by a user, and convenience is improved.

In such a case, the image distribution server may set the predetermined time and create the distribution data in accordance with at least one of: an interval or frequency of input of the image data to the image storage device, an interval or frequency of input of the switching request, an interval or frequency of requests for image data from the image display browser, congestion of a distribution path when distributing the image data, or an identification number identifying a client at which the image display browser is installed.

The image distribution server may both receive the request from the image display browser and distribute the image data by wireless communications.

Accordingly, such an image distribution server can be portably moved.

According to a third aspect of the invention, there is provided An image distribution method comprising: inputting a request to acquire image data; when the request is inputted, switching an image storage device, which includes a storage section which has stored the image data, to a mass storage mode by outputting a switching signal to the image storage device; acquiring the image data from the storage section of the image storage device which has been switched to the mass storage mode; and distributing the acquired image data in response to a request from an image display browser.

The image distribution method of this aspect operates similarly to the image distribution system of the present invention. Therefore, it is possible to switch the operation mode of the image storage device and acquire the image data under the guidance of an image distribution server, rather than providing a dedicated function at the image storage device. Therefore, the image data can be acquired from the image storage device simply and reliably without complex control, and images of the acquired image data can be seen via an image display browser installed at a PC or the like.

According to the present invention as described above, without dedicated functions being provided at an image storage device such as a camera or the like, functions which have been widely installed in previous image storage devices can be employed to acquire image data from the image storage device simply and reliably without complex control being performed, and images of the acquired image data can be viewed via an image display browser installed at a PC or the like.

What is claimed is:

1. An image distribution system comprising:
an image storage device including a storage section which stores image data, the image storage device switching to a mass storage mode when a switching signal is inputted; and
an image distribution server which outputs the switching signal to the image storage device when there is a request from an external section, acquires the image data from the storage section of the image storage device which has switched to the mass storage mode, and distributes the acquired image data in response to a request from an image display browser.

2. The image distribution system of claim 1, wherein
the image distribution server continues output of the switching signal during acquisition of the image data or from commencement of output of the switching signal until there is a request from the external section to stop output of the switching signal, and
after switching to the mass storage mode, the image storage device switches from the mass storage mode to a pre-specified operation mode when the switching signal ceases to be inputted.

3. The image distribution system of claim 1 wherein,
when the image distribution server has finished acquiring the image data or when there is a request from the external section, the image distribution server outputs a cancellation signal for canceling the mass storage mode, and
when the cancellation signal is inputted, the image storage device switches from the mass storage mode to a pre-specified operation mode.

4. The image distribution system of claim 1, wherein
the image distribution server acquires the image data by communications conforming to a USB standard, and outputs USB bus power as the switching signal, and
the image storage device switches to the mass storage mode when the USB bus power is inputted.

5. The image distribution system of claim 1 wherein, when the image distribution server is to distribute the image data, the image distribution server creates distribution data for causing the image display browser to request distribution of the image data at a predetermined time interval, and distributes the distribution data with the image data.

6. The image distribution system of claim 5, wherein the image distribution server sets the predetermined time and creates the distribution data in accordance with at least one of
an interval or frequency of input of the image data to the image storage device,
an interval or frequency of input of the switching request,
an interval or frequency of requests for image data from the image display browser,
congestion of a distribution path when distributing the image data, or
an identification number identifying a client at which the image display browser is installed.

7. The image distribution system of claim 1, wherein the image distribution server both receives the request from the image display browser and distributes the image data by wireless communications.

8. The image distribution system of claim 1, wherein the image storage device comprises a digital camera or a portable hard disk device.

9. An image distribution server wherein
the image distribution server is connectable with an image storage device including a storage section which stores image data, the image storage device switching to a mass storage mode when a switching signal is inputted, and
the image distribution server outputs the switching signal to the image storage device when there is a request from an external section, acquires image data from the storage section of the image storage device which has switched to the mass storage mode, and distributes the acquired image data in response to a request from an image display browser.

10. The image distribution server of claim 9, wherein the image distribution server continues output of the switching signal so as to maintain the mass storage mode of the image storage device during acquisition of the image data or from commencement of output of the switching signal until there is a request from the external section to stop output of the switching signal.

11. The image distribution server of claim 9 wherein, when the image distribution server has finished acquiring the image data or when there is a request from the external section, the image distribution server outputs a cancellation signal to the image storage device for canceling the mass storage mode.

12. The image distribution server of claim 9, wherein the image distribution server acquires the image data by communications conforming to a USB standard, and outputs USB bus power as the switching signal.

13. The image distribution server of claim 9 wherein, when the image distribution server is to distribute the acquired image data, the image distribution server creates distribution data for causing the image display browser to request distribution of the image data at a predetermined time interval, and distributes the distribution data with the image data.

14. The image distribution server of claim 13, wherein the image distribution server sets the predetermined time and creates the distribution data in accordance with at least one of
an interval or frequency of input of the image data to the image storage device,
an interval or frequency of input of the switching request,
an interval or frequency of requests for image data from the image display browser,
congestion of a distribution path when distributing the image data, or
an identification number identifying a client at which the image display browser is installed.

15. The image distribution server of claim 9, wherein the image distribution server both receives the request from the image display browser and distributes the image data by wireless communications.

16. An image distribution method comprising:
inputting a request to acquire image data;
when the request is inputted, switching an image storage device, which includes a storage section which has stored the image data, to a mass storage mode by outputting a switching signal to the image storage device;
acquiring the image data from the storage section of the image storage device which has been switched to the mass storage mode; and
distributing the acquired image data in response to a request from an image display browser.

17. The image distribution method of claim 16, wherein the switching further comprises continuing output of the switching signal during the acquiring of the image data or from commencement of output of the switching signal until there is a request from the external section to stop output of the switching signal, and the method further comprising:
after the image storage device has switched to the mass storage mode, switching the image storage device from the mass storage mode to a pre-specified operation mode when the switching signal ceases to be inputted.

18. The image distribution method of claim 16, further comprising, when the acquiring of the image data has finished or when there is a request from the external section, switching the image storage device from the mass storage mode to a pre-specified operation mode by outputting a cancellation signal for canceling the mass storage mode.

19. The image distribution method of claim 16, wherein
the switching further comprises switching to the mass storage mode by outputting USB bus power to the image storage device as the switching signal, and
the acquiring further comprises acquiring the image data by communications conforming to a USB standard.

20. The image distribution method of claim 16, wherein the distributing further comprises distributing distribution data for causing the image display browser to request distribution of the image data at a predetermined time interval.
